(19) United States
(12) Patent Application Publication
(10) Pub. No.: US 2016/0159132 A1
(43) Pub. Date: Jun. 9, 2016

(54) RivetBooks

(71) Applicant: Karen Starks, Lawrenceville, GA (US)

(72) Inventor: Karen Starks, Lawrenceville, GA (US)

(21) Appl. No.: 14/926,693

(22) Filed: Oct. 29, 2015

Related U.S. Application Data
(60) Provisional application No. 62/088,956, filed on Dec. 8, 2014.

(51) Int. Cl. B42B 5/00; F16B 19/04

(52) U.S. Cl. CPC B42B 5/00; F16B 19/04

(57) ABSTRACT

The present invention relates to a completed book which comprises a front cover (1) with a folding crease (3), back cover (4) and spine (7) which form a covering member for copyrighted media products (9) wherein rivet screws (5) with closed sheaths (6) are inserted through punched holes (2) (8) to form a completed book. According to the invention, this process allows for a completed book to be made at will without special skills, training or the use of ancillary tools. This process does not use glue, a helical coil, staples or stitching.

### CROSS REFERENCE

This applicant claims the benefit of one prior-filed Provisional Patent application by Karen Starks (U.S. 62/088,956 RivetBooks) and cross-references the following patents (US 20100158637 A1 and U.S. Pat. No. 8,287,205) as related and appropriate to current application:
1. U.S. 62/088,956—RivetBooks by Karen Starks (Lawrenceville, Ga.)
2. US 20100158637 A1—“book and method of making the same—binding using glue” by Manico; Joseph A. (Rochester, N.Y.), Devoy; James M. (Rochester, N.Y.), Fowlkes; William Y. (Pittsford, N.Y.), Cornell; David J. (Scottsville, N.Y.)
3. U.S. Pat. No. 8,287,205—“Method for binding a book with a helical plastic coil” by Desjarlais; Matthew G. (Winnipeg, Calif.), Klassen; Walter D. (Winnipeg, Calif.)

### EXPLANATION

1. U.S. 62/088,956—RivetBooks—filed Dec. 8, 2014—Provisional Patent
   Rivetbooks is a book construction system for quickly connecting pages of Rivetbooks' copyrighted media products between two artistically decorated book covers. Two separate sheets of cover stock form the front and back cover; a spine (made of thin cover stock) will be inserted to hide media page edges; then the front and back covers and spine will be attached with five (5) metal or plastic rivet screws to form a book. The types of media products include stories, poems, songs and other similar written media forms. Each media product will include illustrations, photographs and/or art designs. This construction method does not require special skills, training or use of ancillary equipment. There is no use of glue, a helical coil or other binding material. The goal of this process is to allow the purchaser to easily add or remove Rivetbooks media products at will.
2. US 20100158637 A1—Book and method of making the same—binding using glue
   According to the summary of this invention: “A book and a method of forming the same is disclosed, wherein the book includes a book cover capable of accepting media. The book cover includes a front cover, a back cover, and a spine section there between, wherein an adhesive strip is adhered to the spine, with the side of the adhesive strip opposite the spine having a release strip removably attached. The adhesive strip has a peak load gram force per inch of at least 200 and a thickness of at least 0.1 mm. The book is formed by optionally attaching the adhesive strip if not already in place, assembling media for insertion, removing the release strip from the adhesive strip, and pressing the media into the adhesive strip. The resulting book can be opened such that adjacent pages can form an angle of at least 150 degrees.”
3. U.S. Pat. No. 8,287,205—“Method for binding a book with a helical plastic coil”
   According to the summary of this invention: “A helical plastic coil is used for binding a collated book having a stack of pages with aligned holes along one edge of the book where a leading end of the filament is fed into a first hole at a first end of the book and the coil is rotated about its axis such that the leading end is threaded through the holes by entering each of the holes until the coil is threaded through all of the holes. The leading end of the coil is sheared by an anvil and blade so as to define a leading apex and a leading surface inclined rearwardly from the leading apex along the filament and across the filament. The leading apex is arranged such that, as the leading end enters each of the holes in turn, the leading apex is located on the leading end of the filament at a position thereon facing away from the trailing end of the coil and spaced from the end of the hole facing the first end of the book.”

### STATEMENT REGARDING FEDERALLY SPONSORED RESEARCH OR DEVELOPMENT

Not applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

The field of endeavor is processes and apparatuses for the manufacture or making a book, its associated elements, including the assembly of any or all its elements to each other or to the book and includes terms as defined by the USPTO Class 412 Bookbinding and Apparatus Glossary of Terms.

The purpose of this invention is to allow a purchaser to form a completed book′ “at will” (e.g. the purchaser decides which media to include, when to make the book, the number of books to make, etc.) thereby removing these decisions from the sole discretion of a publisher. The prior art of book making includes US 20100158637 A1 (Book and method of making the same) and U.S. Pat. No. 8,287,205 (Method for binding a book with a helical plastic coil). US 20100158637 A1 uses glue on the spine to form a book and U.S. Pat. No. 8,287,205 uses a helical plastic coil to connect the covering member (front and back boards²) to the book³ to form a completed book. These existing methods are problematic because each forms a completed book prior to the purchase of the book and thus prevents the addition of media “at will” by the purchaser. ¹ A completed book is a book which has had its covering member attached.² Boards consists of hard card stock.³ A book consists of two or more sheets secured together either: (a) only at their margins; or (b) only at a restricted field within the margins; or (c) only at their margins and at a restricted field within the margins. When a margin of one sheet is attached to a margin of another sheet to obtain in effect a single sheet or greater area, the resulting article is still regarded as a sheet rather than a book. A folded sheet is not considered to be a book. Book and bound book are synonymous terms and in both, a covering member has not yet been applied.

RivetBooks resolves this specific problem by providing a method where a completed book can be easily created “at will” (e.g. the purchaser decides which media to include, when to make the book, the number of books to make, etc.) thereby removing these decisions from the sole discretion of a publisher. RivetBooks allows the purchaser to form a completed book by securing the margins of the book with an easily attached covering member (consisting of front and back boards and spine⁴) using rivets screws with closed sheaths. The purchaser can customize a RivetBook with an eclectic mix of art, stories, songs, text or poetry from the same or different authors and illustrators to form one completed book. ⁴ Spine—the hollow or portion of the covering member which connects the boards

### BRIEF SUMMARY

The main advantage of RivetBooks is that it allows the purchaser to make a completed book “at will” (e.g. the purchaser decides which media to include, when to make the book, the number of books to make, etc.) thereby removing these decisions from the sole discretion of a publisher. To create a completed book “at will”, first, the purchaser will select a cover from a variety of designs and book titles. Second, the purchaser will select the copyrighted media products to include in the completed book. The purchaser can select RivetBooks' copyrighted media products with pre-punched holes or the purchaser can choose to use their own copyrighted media products. RivetBooks' copyrighted media products includes but are not limited to art, songs, stories and poems by an array of writers and artists. The purchaser can choose to mix any of the aforementioned media in one completed book. Lastly, the purchaser will attach the covering member (which includes the front and back boards and spine) to the media contents using rivet screws with closed sheaths to form a completed book. This “at will” process does not require special skills, training or the use of ancillary tools. This process does not use glue, a helical coil, staples or stitching.

A related advantage is that artists and writers will have a marketplace for selling their copyrighted media products in a variety of formats (e.g. a single poem may be purchased for inclusion in a RivetBook). Such a marketplace increases the opportunity for artists and writers to make an income from their copyrighted media products without losing their rights to the product.

### BRIEF DESCRIPTION OF DRAWINGS

FIG. 1: Front book cover (1) has five (5) ½ inch punched round holes (2) in left side of cover inserted ½ inch from left cover edge. The front book cover (1) is a standard 10.25 (length) by 10.25 (width) with a folding crease (3). The folding crease (3) is 1 inch from left cover edge.

FIG. 2: Back book cover (4) with five (5) ½ inch punched round holes (2) in left side of cover inserted ½ inch from left cover edge. The back cover (4) is 10.25 (length) by 10.25 (width) and no folding crease on back cover.

FIG. 3: Rivet screw (5) and closed sheath (6)

FIG. 4: Spine (7) with five (5) three-fourths (¾) inch elongated holes (8) are ½ inch from left spine edge and five (5) ½ inch round holes (2) are ½ inch from right spine edge.

FIG. 5: Front view of media product (9) inserted in spine (7) and aligned with elongated and round holes in spine

FIG. 6: Construction of a RivetBook—(illustrated using one rivet screw and sheath)
Step 1: the rivet sheath (6) is inserted through top hole (2) of back cover;
Step 2: insert rivet sheath (6) through the spine (7) which contains the media product (9) whose round hole has been aligned with elongated and round holes of the spine;
Step 4: insert the rivet sheath (6) through top round hole (2) in the front cover (1); and
Step 5: insert the rivet screw (5) in the closed rivet sheath (6) and turn rivet screw clockwise until tight.

FIG. 7: Front (1), back (4) and side (7) view of a constructed RivetBook which includes media product with rivet screws inserted in closed sheaths

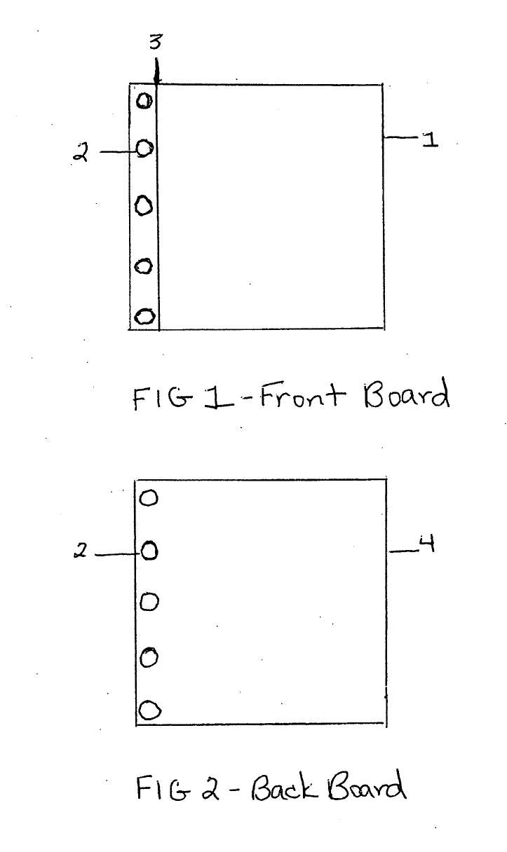

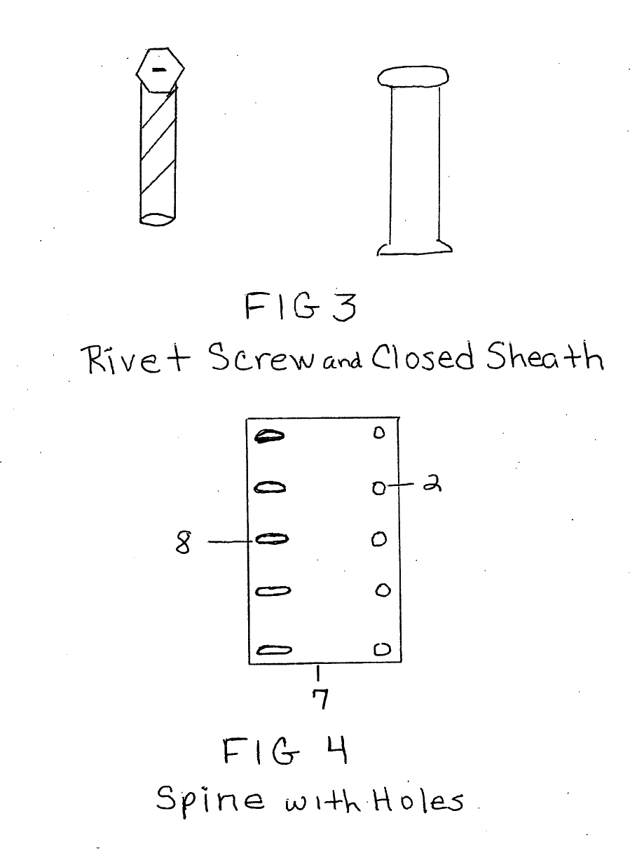

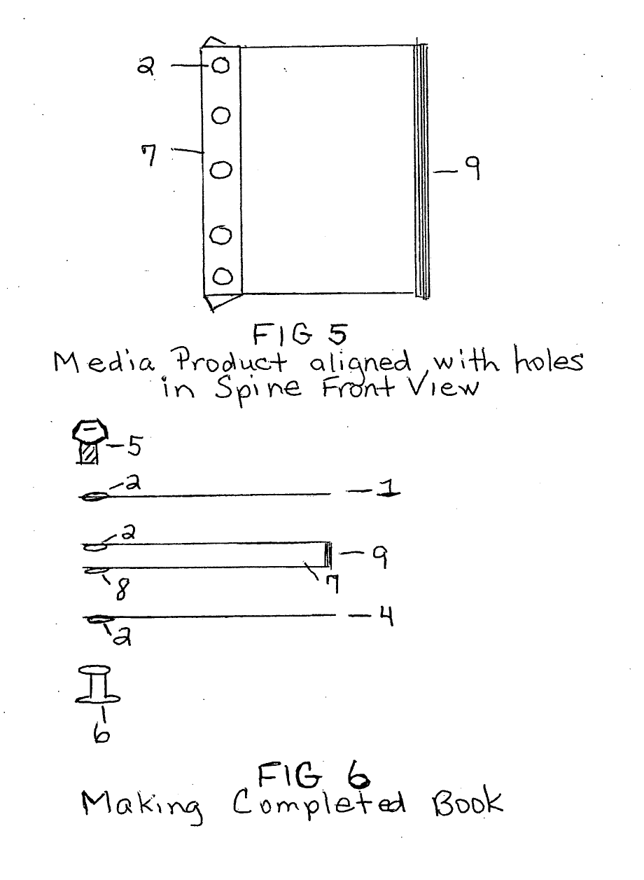

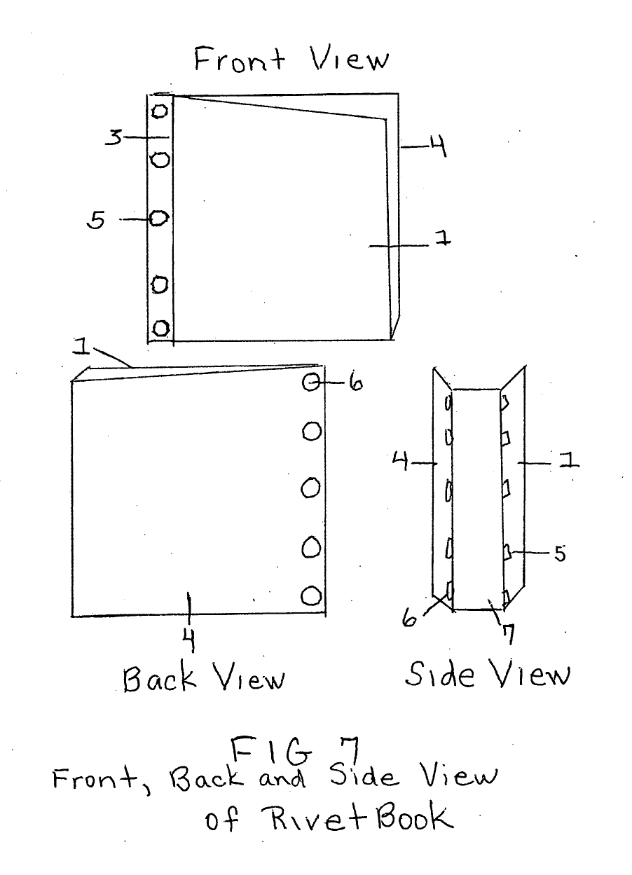

### DETAILED DESCRIPTION OF INVENTION

RivetBooks is a process that allows the purchaser to make a completed book “at will” (e.g. the purchaser decides which media to include, when to make the book, the number of books to make, etc.). This “at will” process does not require special skills, training or the use of ancillary tools. This process does not use a helical coil, glue, staples or stitching. The materials needed to make a RivetBook are one front board, one back board, one spine, copyrighted media products and rivet screws with closed sheaths. The number of rivet screws with closed sheaths will correspond to the number of holes on the boards. The standard 10.25×10.25 boards will have five (5) holes; 5.50×8.5 boards will have four (4) holes, etc.

Each front and back board is one-eighth (⅛) inch in width and the overall dimensions would be similar to current industry book sizes (e.g. 10.25×10.25; 5.50×8.50; etc.). The front board has a crease (fold) line which allows front board to be opened such that two adjacent pages can form an angle of at least 150 degrees. The back board does not have a crease (fold) line.

The front and back boards have symmetrically aligned round holes. Front and back boards will extend over the size of the media by one-fourth (¼) inch to ensure that copyrighted media product is covered.

The spine will have symmetrically aligned holes that correspond to the chosen board size. The holes on the left side of the spine are elongated three-fourths (¾) inch long so the spine can be slightly adjusted to fit the contents of the book. The symmetrically aligned holes on the right side of the spine are one-half (½) inch and are round, not elongated. Spines will be available in four (4) widths: one-fourth (¼) inch, one-half (½) inch, three-fourths (¾) inch and one (1) inch.

The RivetBooks' copyrighted media products will have symmetrically aligned round one-half (½) inch holes punched into each sheet of paper. The copyrighted media will be in the form of books and sheets, which are copied front to back, not V-shaped.

Rivet screws and closed sheaths will be included to accommodate the copyrighted media product to the thickness of one-fourth (¼) inch, one-half (½) inch, three-fourths (¾) inch and one (1) inch. The rivet screws and closed sheaths will be made of metal or plastic.

To construct a RivetBook, place all materials listed above on a flat surface such as a table top. Align the copyrighted media product with the holes in the spine and set to the side. Place one rivet sheath top-side up through each hole of the back board. Next insert the rivet sheaths, top-side up, through corresponding back holes in the spine, the copyrighted media product and the front holes of the spine. Next, insert the rivet sheaths, top-side up, through the corresponding holes in the front board. Lastly, insert a rivet screw into the top of each rivet sheath and turn in a right rotation to create a tight fit.

1. A process of making a completed book comprising one front board, one back board, one spine using rivet screws with closed sheaths.

2. The method of claim 1, whereas the front board has a crease (fold) line which allows front board to be opened such that two adjacent pages can form an angle of at least 150 degrees.

3. The method of claim 1, whereas the front and back boards have symmetrically aligned round holes.

4. The method of claim 1, whereas the spine will have elongated holes on its left side and round holes on its right side corresponding to the number of holes on front and back boards.

5. The method of claim 1, whereas the copyrighted media will be in the form of a book comprised of two or more sheets, having symmetrically aligned round holes, copied front to back, not V shaped.

6. The method of claim 1, whereas the closed rivet sheaths are placed, top-side up, through corresponding holes in the back board, spine, copyrighted media product and front board.

7. The method of claim 1, whereas the rivet screw is inserted into the top-side of the closed rivet sheath and turned in a right rotation to create a tight fit.
